(19) United States
(12) Patent Application Publication
(10) Pub. No.: US 2011/0078201 A1
(43) Pub. Date: Mar. 31, 2011

(54) RAGGED AND UNBALANCED HIERARCHY MANAGEMENT AND VISUALIZATION

(75) Inventors: Thomas K. Ryan, Valley Center, CA (US); Carl L. Christofferson, Escondido, CA (US); Neelesh V. Bansode, Bangalore (IN); Vivek Shandilya, Bangalore (IN); Latesh Pant, Bangalore (IN); Madhavi Chandrashekhar, Bangalore (IN)

(73) Assignee: TERADATA US, INC., Miamisburg, OH (US)

(21) Appl. No.: 12/822,962

(22) Filed: Jun. 24, 2010

Related U.S. Application Data
(60) Provisional application No. 61/247,405, filed on Sep. 30, 2009.

(51) Int. Cl. G06F 17/30

(52) U.S. Cl. 707/792; 707/805; 707/E17.005; 707/E17.045

(57) ABSTRACT

A method, apparatus, and article of manufacture provide the ability to define a view of data in a computer system A relational database management system (RDBMS) executes and stores the information in the computer system. As part of a process and framework, a series of business rules and process workflows are maintained to manage hierarchical data that resides in RDBMS tables. User input is accepted that defines a hierarchy that is projected onto the data. The hierarchy may be parent-child relationships with no level consistency. Alternatively, the hierarchy may have branches and levels, with each of the levels having a consistent meaning but inconsistent depths due to one level of a branch being unpopulated. The hierarchy is stored as metadata in the RDBMS and utilized to graphically visualize, manage, and manipulate the data.

### CROSS-REFERENCE TO RELATED APPLICATIONS

This application claims the benefit under 35 U.S.C. Section 119(e) of the following co-pending and commonly-assigned U.S. provisional patent application(s), which is/are incorporated by reference herein:

Provisional Application Ser. No. 61/247,405, filed Sep. 30, 2009, by Thomas K. Ryan, Carl L. Christofferson, Neelesh V. Bansode, Vivek Shandilya, Latesh Pant, and Madhavi Chandrashekar entitled “Ragged and Unbalanced Hierarchy Management and Visualization,” attorneys' docket number 20414 (30145.472-US-U1).

This application is related to the following co-pending and commonly-assigned patent application, which application is incorporated by reference herein:

U.S. patent application Ser. No. 12/574,509, entitled “HIERARCHY MANAGER FOR MASTER DATA MANAGEMENT”, by Brian J. Wasserman, Thomas K. Ryan, Carl L. Christofferson, Neelesh V. Bansode, Santosh Kumar Singh, Madhavi Chandrashekar, and Vivek Shandilya, Attorney Docket No. 20001 (30145.467-US-U1), filed on Oct. 6, 2009, which application claims priority to Provisional Application Ser. No. 61/195,321, filed Oct. 6, 2008, Brian J. Wasserman, Thomas K. Ryan, Carl Christofferson, Neelesh V. Bansode, Santosh Kumar Singh, Madhavi Chandrashekar, and Vivek Shandilya, entitled “Hierarchy Manager for Master Data Management,” attorneys' docket number 20001 (30145.467-US-U1).

### BACKGROUND OF THE INVENTION

1. Field of the Invention

This invention relates in general to managing business critical data in a computer, and in particular, to defining and viewing a ragged and unbalanced hierarchical view of such data.

2. Description of Related Art

Master Data Management™ (MDM), available from the assignee of the present invention, is an application that allows users to manage their business critical data. This critical data can originate from a myriad of sources and external feeds, but ultimately, the goal is that all of this data be consolidated into a central business data warehouse. Master Data Management™ is the process and framework for maintaining a series of business rules and process workflows that will manage this data as it feeds in from multiple sources. Master Data Management™ then applies these business rules and process workflows to produce and/or manage “master” data, which is then fed to all consuming business processes.

Core to the management of master data is the definition of a data model. The data model serves as the foundation for all business rules and workflow processes within the Master Data Management™ (MDM) framework. The data model represents the form the master data must ultimately take in the customer's data warehouse to be used by the consuming business applications.

A significant portion of the business critical master data consists of “data relationship” data itself. Relationship Data is the data required to manage the association of one piece of data (typically a data entity or table) to another. The data relationship can take the form of a hierarchy or a direct reference or any other association. Management of the relationship or association requires data and business processes that are key to the concept of Master Data Relationship Management. The Relationship Data resides in a series of MDM tables that are part of the core master data. The data in these tables is hierarchical in nature, meaning that the data consists of parent-child relationships, generally represented through primary key—foreign key relationships in the underlying data. A common requirement for customers in an MDM context is the ability to manage and manipulate the hierarchical data, and central to this is the necessity to be able to view this data in a visual hierarchy.

Prior art systems provide generalized solutions for viewing and manipulating hierarchical data (e.g., Entreon™). However, prior art systems fail to integrate hierarchies, the management of hierarchies, and the visualization and direct manipulation of hierarchies in an MDM solution. In addition, prior art solutions fail to provide support for all of the types of hierarchies.

In addition, hierarchical data need not always be structured in nature (balanced) with consistent depth of each node (a node is a level) in a hierarchy. Further, many business requirements/scenarios are such that the hierarchy needs to be visualized as just parent-child node (unbalanced) and at times some of the intermediate nodes may be missing in a hierarchy (ragged) but the depth of the nodes need to remain consistent. Prior art solutions fail to provide the capabilities to visualize and manipulate such an unbalanced and ragged hierarchy.

### SUMMARY OF THE INVENTION

In order to view business critical master data in a hierarchical manner—thus viewing the underlying data relationships visually—it is first necessary to define the structure of the hierarchy itself. Embodiments of the invention provide for a Hierarchy Manager that is responsible for allowing users to define multiple hierarchies that in turn can be projected on the data, and used to visually present the data to users. The hierarchy definition also governs the interactions that users can have with the hierarchy data.

More specifically, embodiments of the invention allow users to access their hierarchical data (data that is governed by the MDM framework and processes) and create multiple hierarchies from this data and present it as a visual hierarchy. Users can interact directly with the data, either to view or edit details of the data element, or to drag and drop, as well as cut and paste, the item to change its hierarchical parentage.

Hierarchical data in reality need not always be structured in nature (balanced hierarchy) with consistent depth of each node (node is essentially a hierarchical level) in a hierarchy. In this regard, embodiments of the invention provide that the hierarchical data may consist of parent-child relationships with no level consistency (unbalanced hierarchy) or hierarchical data in which each level has a consistent meaning, but the branches have inconsistent depths because at least one member in a branch is unpopulated (ragged hierarchy).

### BRIEF DESCRIPTION OF THE DRAWINGS

Referring now to the drawings in which like reference numbers represent corresponding parts throughout:

FIG. 1 illustrates an exemplary hardware and software environment according to the preferred embodiment of the present invention;

FIG. 2 illustrates an example of a balanced time hierarchy in accordance with one or more embodiments of the invention;

FIG. 3 illustrates an example of an unbalanced hierarchy for an organization chart in accordance with one or more embodiments of the invention;

FIG. 4 is an example of a ragged hierarchy in accordance with one or more embodiments of the invention;

FIG. 5 illustrates the architecture of a hierarchy manager in accordance with one or more embodiments of the invention; and

FIG. 6 is a flow chart illustrating the logical flow for visualizing a structured view of data in a computer system in accordance with one or more embodiments of the invention.

### DETAILED DESCRIPTION OF THE PREFERRED EMBODIMENT

In the following description of the preferred embodiment, reference is made to the accompanying drawings, which form a part hereof, and in which is shown by way of illustration a specific embodiment in which the invention may be practiced. It is to be understood that other embodiments may be utilized and structural changes may be made without departing from the scope of the present invention.

### Overview

One or more embodiments of the invention provide a Hierarchy Manager and Viewer that are applications that are integrated directly into the Master Data Management (MDM) Framework. The Hierarchy Manager and Viewer provide the ability for users to visualize the master data in a hierarchical fashion. Users can also interact directly with this data, to access detailed information about specific data elements, or to manipulate the master data in a way the modifies the hierarchical relationships of the data. Further embodiments of the invention provide enhancements to existing Hierarchy Managers and Viewers (as described in co-pending application Ser. No. 12/574,509 identified above) where users can view their hierarchical master data in multiple types of hierarchies.

### Framework/Workflow Overview

In a Master Data Management (MDM) Framework, all the master data is accessed only by MDM sanctioned data processes, also called “workflows”. These workflows are central to the concept of having master data, as they become the only means by which the underlying core data can be modified. Essentially, all inbound data passes through one or more workflows that can perform the following actions on the inbound data:
Perform data quality checks;
Perform data validation;
Perform data transformations (or cleanup of data);
Identify errors in the underlying data and notify the data steward of these issues; and
Migrate data into the Master or “Gold” copy of the data, where it resides in a protected manner.

### Hardware and Software Environment Overview

Master data (sometimes referred to as reference data) are facts that define a business entity, facts that may be used to model one or more definitions or view of an entity. Entity definitions based on master data provide business consistency and data integrity when multiple systems across an organization (or beyond) identify the same entity differently (e.g., in differing data models).

Business entities modeled via master data are usually customer, product, or finance. However, master data can define any entity, like employee, supplier, location, asset, claim, policy, patient, citizen, chart of accounts, etc.

A system of record is often created or selected (also referred to as a trusted source) as a central, authenticated master copy from which entity definitions (and physical data) are propagated among all systems integrated via a Master Data Management™ (MDM) framework.

The system of record can take many forms. Many users build a central database (e.g. a data warehouse or operational data store) as a hub through which master data, metadata, and physical data are synchronized. Some hubs are simply master files or tables that collect and collate records.

Regardless of the technology approach, embodiments of the invention provide the ability to deploy a system on any designated target system for testing or production.

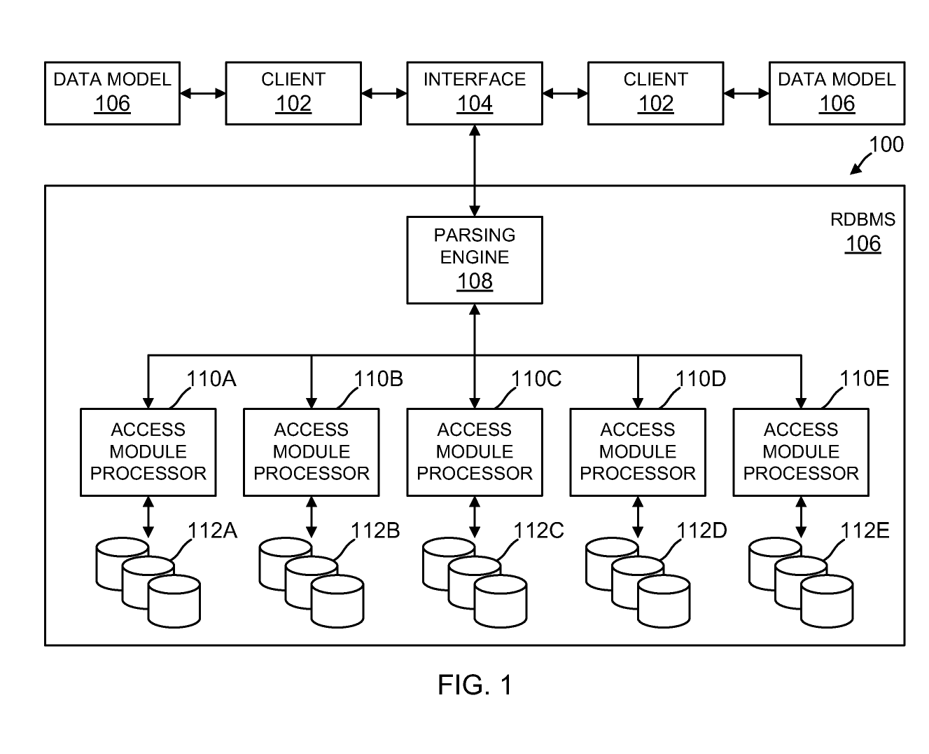

FIG. 1 illustrates an exemplary hardware and software environment according to the preferred embodiment of the present invention. In the exemplary environment, a computer system 100 implements an improved MDM framework 100, in a three-tier client-server architecture, wherein the first or client tier provides clients 102 that may include, inter alia, a graphical user interface (GUI), the second or middle tier provides an interface 104 for performing functions and interfacing with a central database or data warehouse as described later in this application, and the third or server tier comprises the central database or data warehouse (also referred to as a Relational DataBase Management System (RDBMS) 106) that stores data and metadata in a relational database. Such an RDBMS 106 is utilized to store the master data and provide a standard format within framework 100 for the master data. The first, second, and third tiers may be implemented in separate machines, or may be implemented as separate or related processes in a single machine.

In the preferred embodiment, the RDBMS 106 includes at least one parsing engine (PE) 108 and one or more access module processors (AMPs) 110A-110E storing the relational database in one or more data storage devices 112A-112E. The parsing engine 108 and access module processors 110 may be implemented in separate machines, or may be implemented as separate or related processes in a single machine. The RDBMS 106 used in the preferred embodiment comprises the Teradata® RDBMS sold by Teradata™ US, Inc., the assignee of the present invention, although other DBMS's could be used. In this regard, Teradata® RDBMS is a hardware and software based data warehousing and analytic application/database system.

Generally, clients 102 include a graphical user interface (GUI) for operators or users of the system 100, wherein requests are transmitted to the interface 104 to access data stored in the RDBMS 106, and responses are received therefrom. In response to the requests, the interface 104 performs the functions described below, including formulating queries for the RDBMS 106 and processing data retrieved from the RDBMS 106. Moreover, the results from the functions performed by the interface 104 may be provided directly to clients 102 or may be provided to the RDBMS 106 for storing into the relational database. Once stored in the relational database, the results from the functions performed by the interface 104 may be retrieved more expeditiously from the RDBMS 106 via the interface 104. Further, each client 102 may have other data models 106.

Note that clients 102, interface 104, and RDBMS 106 may be implemented in separate machines, or may be implemented as separate or related processes in a single machine. Moreover, in one or more embodiments, the system 100 may use any number of different parallelism mechanisms to take advantage of the parallelism offered by the multiple tier architecture, the client-server structure of the client 102, interface 104, and RDBMS 106, and the multiple access module processors 110 of the RDBMS 106. Further, data within the relational database may be partitioned across multiple data storage devices 112 to provide additional parallelism.

Generally, the clients 102, interface 104, RDBMS 106, parsing engine 108, and/or access module processors 110A-110E comprise logic and/or data tangibly embodied in and/or accessible from a device, media, carrier, or signal, such as RAM, ROM, one or more of the data storage devices 112A-112E, and/or a remote system or device communicating with the computer system 100 via one or more data communications devices. The above elements 102-112 and/or operating instructions may also be tangibly embodied in memory and/or data communications devices, thereby making a computer program product or article of manufacture according to the invention. As such, the terms “article of manufacture,” “program storage device” and “computer program product” as used herein are intended to encompass a computer program accessible from any computer readable device or media. Accordingly, such articles of manufacture are readable by a computer and embody at least one program of instructions executable by a computer to perform various method steps of the invention.

However, those skilled in the art will recognize that the exemplary environment illustrated in FIG. 1 is not intended to limit the present invention. Indeed, those skilled in the art will recognize that other alternative environments may be used without departing from the scope of the present invention. In addition, it should be understood that the present invention may also apply to components other than those disclosed herein.

### Hierarchy Manager and Viewer Overview

As described above with respect to FIG. 1, the master data is stored in RDBMS 106 and is accessed by clients 102 via interface 104. Such client 102 access through interface 104 is enabled by MDM sanctioned data processes referred to as workflows (e.g., provided in interface 104). Rather than being provided via interface 104, such workflows may be provided as part of parsing engine 108 or be provided by the AMPs 110 (or other parts of RDBMS 106). Consumer applications and processes may execute on clients 102 and may need to receive data from the RDBMS 106.

The interface 104 to the data may provide a hierarchy manager or hierarchy viewer that provides the ability for users to access, visualize, manage and manipulate the hierarchy data stored in the RDBMS 106.

The hierarchy manager is a feature to MDM that allows users to define a hierarchy structure that effectively mirrors the hierarchical nature of their data. This hierarchy structure can then be used to drive a hierarchy viewer and drive reporting processes.

The hierarchy viewer provides the ability to visually view and interact with hierarchical data. Accordingly, the viewer is a data visualization feature that allows users to visualize their business critical hierarchical data (e.g., in a visual hierarchy). To utilize the viewer, users select a dimension and hierarchy that results in the display of all top-level member data (from the selected hierarchy). The hierarchy viewer may provide the ability for a user to view their hierarchical data in multiple types of hierarchies.

The various hierarchies and their differences are explained individually with examples. There are four (4) different types of hierarchies: (1) structured or balanced; (2) ragged; (3) unbalanced; and (4) node network.

Balanced Hierarchy

A balanced hierarchy is a hierarchy with meaningful levels and branches that have consistent depth. Each level's logical parent is in the level directly above it. A balanced hierarchy can represent time where the meaning and depth of each level, such as Year, Quarter, and Month is consistent. Balanced hierarchies are consistent because each level represents the same type of information, and each level is logically equivalent.

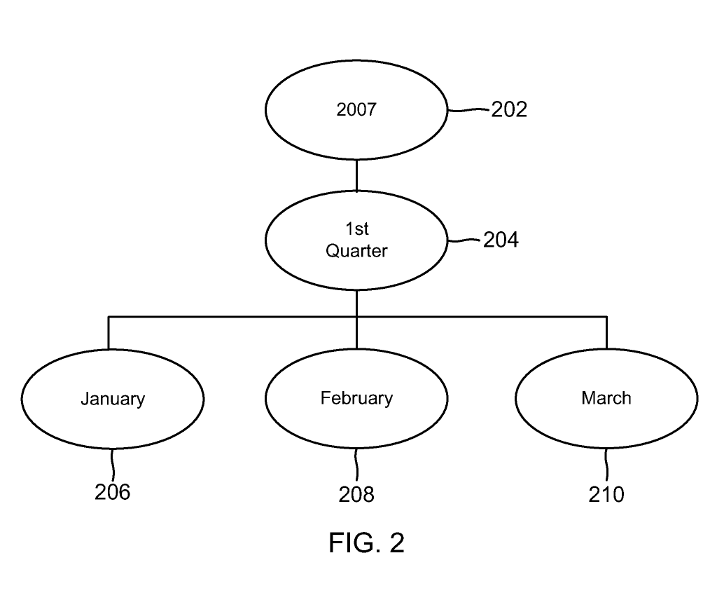

FIG. 2 illustrates an example of a balanced time hierarchy in accordance with one or more embodiments of the invention. As illustrated, the root year node 202 has the 1st quarter node 204 as a child. Below node/level 204, are the individual month nodes 206-210 for the first quarter node 204. Accordingly, the meaning and depth of each level is consistent and logically equivalent—each level represents the same type of information (i.e., nodes at the year level 202 will all represent years, nodes at the quarter level 204 will all represent quarters of the year 202, and nodes at the month level 206-210 represent months).

Unbalanced Hierarchy

An unbalanced hierarchy is a hierarchy with levels that have a consistent parent-child relationship but have logically inconsistent levels. The hierarchy branches can also have inconsistent depths. In this regard, the logical equivalence of each hierarchy level is not true and the hierarchy is depicted as parent-child. The design involves recursively identifying all relations, calculating the hierarchy levels, and depicting the levels as parent-child relations.

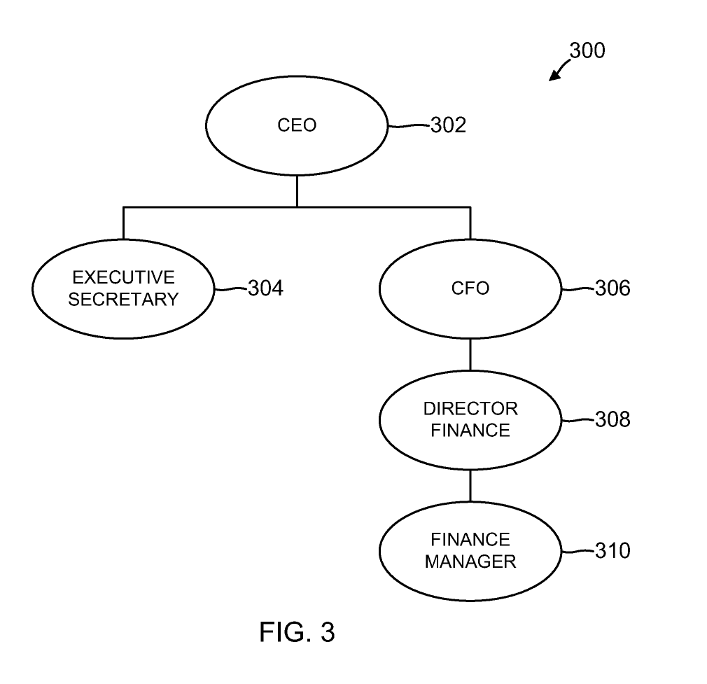

An example of an unbalanced hierarchy is one that represents an organization chart as illustrated in FIG. 3. The example shows a chief executive officer (CEO) 302 on the top level of the hierarchy 300 and at least two of the people that might branch off below including the executive secretary 304 and chief financial officer 306. The chief financial officer 306 has more people branching off also (i.e., the director of finance 308 and finance manager 310), but the executive secretary 304 does not. The parent-child relationships on both branches of the hierarchy 300 are consistent. However, the levels of both branches are not logical equivalents.

Table A illustrates an exemplary organization chart that identifies the different parent-child relationships for an unbalanced hierarchy similar to that of FIG. 3.

TABLE A

| ID | PARENT_ID | DESCRIPTION |
|---|---|---|
| 1 | | CEO |
| 10 | 1 | Executive Secretary |
| 11 | 1 | CTO |
| 100 | 11 | Director of Research and Development |
| 101 | 100 | Engineering Manager |

In Table A, the CEO is the root node with an ID of 1. The executive secretary has an ID of 10 and the parent node of the CEO is identified. Similarly, the CTO has an ID of 11 and also identifies the CEO as the parent node. Below the CTO are the director of research and development with an ID of 100, and the CTO as the parent node, followed by the engineering manager with an ID of 101, and the director of research and development identified as the parent node.

The concept of “level” does not apply to unbalanced hierarchies. In unbalanced hierarchies, the root node is identified and each child node is connected to a parent node by drawing a vertical line of a specified length under the parent node.

Ragged Hierarchy

A ragged hierarchy is a hierarchy in which each level has a consistent meaning, but the branches have inconsistent depths because at least one member attribute in a branch level is unpopulated. The hierarchy becomes ragged when one member does not have an entry at all of the levels. In other words, in ragged hierarchy, each level of the hierarchy has consistent meaning but the intermediate levels may be missing, that is, the levels of hierarchy remain the same irrespective of their parent and level.

To maintain a ragged hierarchy, the levels of each hierarchy object (HO) or relational object (RO) are calculated. This infers that a particular HO/RO may have more than one link/relationship to various other HO/RO. The minimum level of any entity is considered to be its actual level and other levels if any are considered to be ragged.

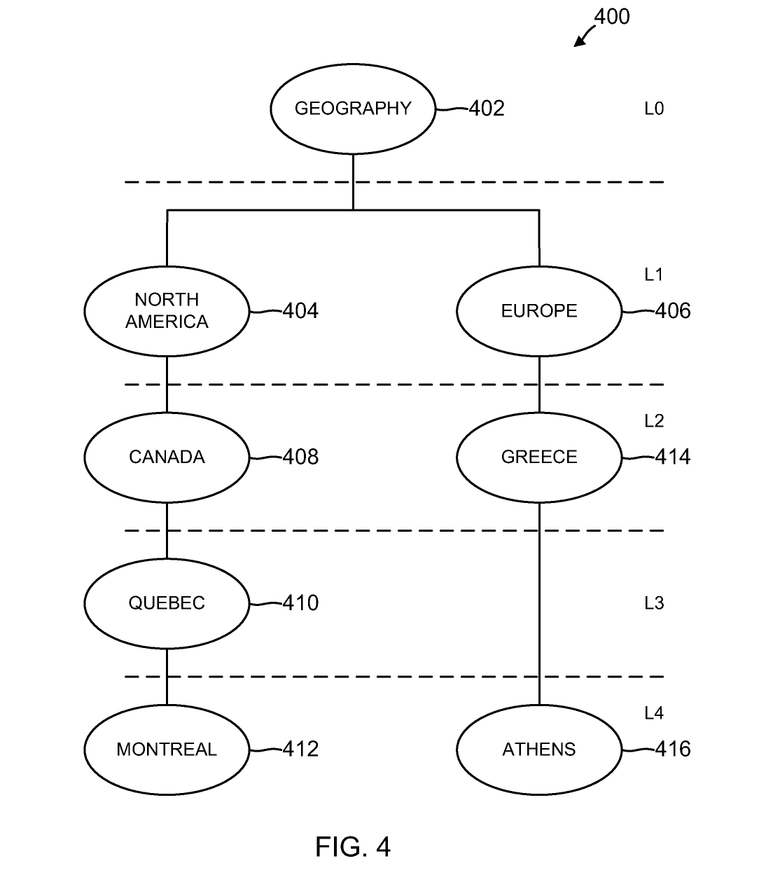

FIG. 4 is an example of a ragged hierarchy in accordance with one or more embodiments of the invention. The example shows geography 402 on the top level of the hierarchy 400. Two continents branch off from the top level 402—North America 404 and Europe 406. North America 404 has a Canada country node 408, a Quebec province node 410, and a Montreal city node 412. Thus, each level in hierarchy 400 is populated on the left/North American 404 branch. However, on the right Europe 406 branch, a level (i.e., an intermediate level) is unpopulated. In this regard, at the country level, there is a Greece node 414. However, there is no state or province node but a city Athens node 416 exists. Accordingly, the level between Greece 414 (i.e., the country level) and Athens 416 (i.e., the city level) is unpopulated resulting in a ragged hierarchy. In this regard, the last level city is related to state as well as country. City as per relations, has two levels: 4 (between state and city) and 3 (between country and city) but graphically and hierarchically, Athens 416 which doesn't have any state would still be required to show on par with other cities. Hence, the level of Athens 416 is calculated as 4.

### Hierarchy Manager and Viewer Details

MDM supports the two additional hierarchy types (ragged and unbalanced) (in addition to the prior hierarchy types of structured/balanced) using a Hierarchy Manager and a Hierarchy Viewer.

The “Hierarchy Manager” allows users with the proper authorization to create or modify the structural composition of a hierarchy. Embodiments of the present invention provide additional features to support the various different hierarchies described above. The Hierarchy Manager is a module where metadata information for a hierarchy is persisted.

The “Hierarchy Viewer” allows users with the proper authorization to view hierarchical data in a graphical display. The idea is to allow users to visualize their hierarchy data in a natural presentation mode.

Hierarchy Manager

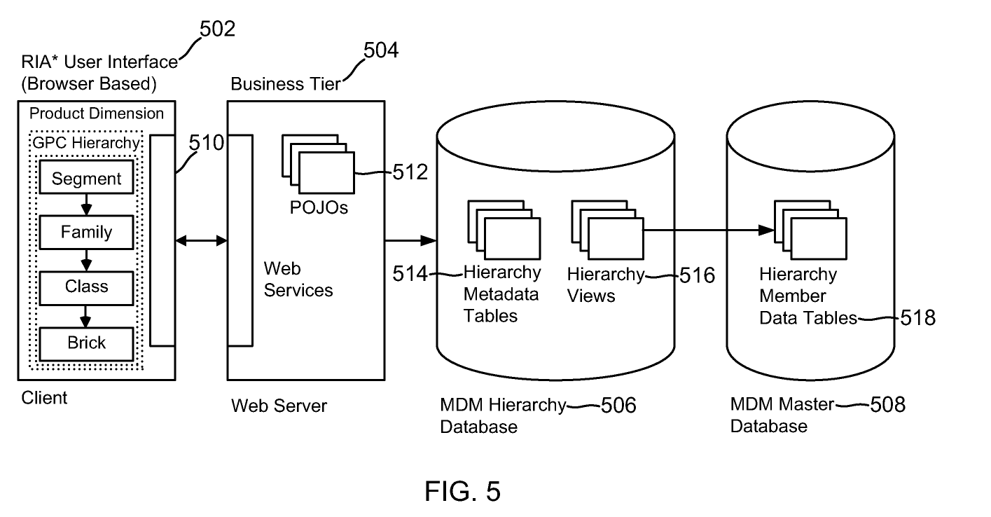

FIG. 5 illustrates the architecture of a hierarchy manager in accordance with one or more embodiments of the invention. Essentially, the Hierarchy Manager will consist of the following components: a user interface 502, a business tier 504, an MDM hierarchy database 506, and the MDM master database 508.

The user interface 502 may be coded in Adobe™ Flex 2 (MXML and ActionScript 3.0). There will be a thin business delegate layer 510 (and supporting data transfer (or value) objects), which serves to separate the business tier 504 logic from the remainder of the presentation logic 502. This business delegate 510 may be written in ActionScript. In addition, various components may be provided (within the user interface 502) to capture the linking of hierarchy objects and the creation of hierarchies.

The business tier 504 resides on a web server, and consists of POJOs 512 (plain old Java™ objects) that handle the majority of the business tier 504 processing. The POJOs 512 are wrapped by a thin web service layer. To capture the different types of hierarchies and to provide other usability, various components may be utilized that persist in a database using prepared statements and stored procedures.

The MDM Hierarchy Database 506 is a database that holds metadata tables 514, hierarchy views 516, and version archives. Metadata tables 514 hold metadata about the Hierarchies. This includes info about the dimensions, hierarchies, hierarchy objects, and hierarchy relationships. Hierarchy views 516 are the primitive database views that map directly to a corresponding table in the MDM Master database 508. Version archives (not pictured) are the historical archives of hierarchy versions, and potentially archives of the member data. In addition, to support the two new different types of hierarchies (ragged and unbalanced) the hierarchy database 506 may have various new columns and tables (as described below).

The MDM master database 508 contains the MDM master tables 518, which contain the member data of the hierarchy objects, as well as the relationships to other hierarchy objects. The hierarchy manager may always read and write through the primitive views that exist in the hierarchy database 506. It does not read/write directly to the Master database 508. However, since the master database 508 contains the master data, it is shown for completeness.

As illustrated in FIG. 5, the business logic (e.g., in business tier 504) may be separated from the presentation logic (e.g., in the UI 502). The Flex™ based UI 502 invokes functions or services that reside on the web server (e.g., either as Web Services or POJOs 512). Access to the business functionality may be “wrapped” in a business delegate class (or classes). The UI 502 may also generate custom ActionScript classes and components wherever necessary. In this regard, most of the hierarchy user interface 502 may rely on dynamically generated user interface objects (e.g., ActionScript based components).

The business tier 504 (webserver/J2EE tier) functionality consists of Java™-based functionality that will reside on the MDM web server. All of the Java™-based functionality may be contained in one or more POJOs 512, and be accompanied by any necessary value (or data transfer) objects. The reason for encapsulating the core functionality in POJOs 512 is that this allows one to ‘wrap’ the functionality with a very thin layer, either via a web service layer, or by a business delegate class. One POJO 512 may be utilized per functional area (e.g., a POJO 512 to handle dimension functionality, one for hierarchy, one for hierarchy object, etc.). The layer wrapping the POJOs 512 may be very thin such that no business functionality is present (such functionality may reside in the POJOs 512). Errors occurring on the server may also be logged. Further, error messages (and other interfaces shown to the user) may be stored in resource bundles.

Metadata defines the various tables to be used to store the data. For example, a dimension table defines a dimension, a hierarchy table defines a hierarchy that belongs to a specific dimension, a hierarchy version contains information about each version of the hierarchy, a hierarchy object table defines a hierarchy object, a hierarchy-to-object mapping table supports the ability to use a hierarchy object in multiple hierarchies, a hierarchy relationship table contains hierarchy relationships (that captures data mappings a PK [primary key] to FK [foreign key] relationship in the data), and a hierarchy relationship map table maps the primary keys in a parent object to a foreign key in a child object.

In view of the above, one may note that three features of the hierarchy manager are useful to better understand the present invention—the user interface, the business tier, and metadata specifications, each of which are discussed in further detail below.

User Interface

The user interface 502 for the hierarchy manager is a rich interface architecture (RIA) that provides for creating a hierarchy, creating a hierarchy object, and linking the hierarchy objects.

As described above, three types of hierarchies can be created using the user interface of the hierarchy manager: (1) a structured hierarchy; (2) a ragged hierarchy; and (3) an unbalanced hierarchy.

The structured hierarchy is available consistent with prior art hierarchy manager implementations.

The ragged hierarchy is a hierarchy that skips levels as described above. The ragged hierarchy may be created similar to the structured hierarchy but provides the ability for the user to select the type of hierarchy. The ragged hierarchy may pull data from master data relationship management tables (MDRM) (i.e., tables for master data that maintains relationships between different nodes).

The unbalanced hierarchy is a hierarchy where levels are not considered but the hierarchy is built out of parent-child relations. The user selects the type of hierarchy as unbalanced. A relation can then be selected (for each parent-child node relation) from a drop-down menu that is populated with valid relations. The valid relations for the drop-down menu can be pulled out from a relational object map table (e.g., entitled “MST-RELATIONAL_OBJECT_MAP), that defines the parent child relations of relational objects. One may note that unlike prior art hierarchies, this hierarchy may not have hierarchy objects (as levels are built on parent-child relations).

Once the hierarchy has been created, hierarchy objects for the hierarchy can be created (e.g., from views and a code master apart from master tables) (but for hierarchies that do not have hierarchy objects). For hierarchies where the hierarchy objects are meant to be created, hierarchy objects may be created similar to their creation in the prior art. However, users may also be presented with an option to create a hierarchy object from Views 516 or Master tables. Once selected, appropriate selection suitable drop-down menus are populated. Further once selected, a visual change in the user interface may be displayed.

Once created, the hierarchy objects may be linked while the user interface 502 may be populated with data from MDRM tables. Similar to creation of hierarchies, an option may be presented to the user to select relations from the already defined MDRM tables or to create new relations. In this regard, an appropriate selection of parent-child relations may be populated in a drop-down menu. If the user elects to select a relation from existing relations defined in MDRM tables, the user may also have the ability to link hierarchy objects with more than one parent.

As described above, the user interface 502 may be coded in Adobe™ Flex 2™ and consists primarily of ActionScript files (ending in “.as”) and MXML files (ending in “.mxml”). Some image files (e.g., .GIF and .JPEG) may also be used to support the user interface 502. New components may be added to MDM 2.0 (i.e., a prior version of software used in embodiments of the present invention) to capture the different types of hierarchies and linking of hierarchy objects.

Business Tier (WebServer/J2EE) 504

The business tier 504 of the hierarchy manager provides methods that support the new hierarchy types (e.g., ragged and unbalanced) of embodiments of the invention. On appropriate request from the user interface (i.e., from a user) for fetching data from MDRM tables (e.g., the relations of relational objects to populate the list of views for creating a hierarchy), the list of views are populated.

To support the new hierarchy types, the business tier 504 provides additional support for hierarchies, hierarchy objects, and hierarchy object relationships. For the hierarchy itself, the new different hierarchy types are added/available and values from the relational object map are populated from the MDRM tables if the user selects an unbalanced hierarchy. In addition, if the hierarchy is unbalanced, a new hierarchy unbalanced table may be populated.

For the hierarchy objects, hierarchy objects for different data source types (e.g., view 516 or table) are added/available while valid available views are populated from the database.

For the hierarchy object relationships, hierarchy relationships are added for appropriate hierarchy objects/hierarchy. Multiple parent-child relations are allowed for hierarchy objects in the case of ragged hierarchies while maintaining their sequence. In addition, data from MDRM tables may be populated in case the user wants to use them.

Metadata Specifications

This section outlines the necessary steps to ensure the successful installation of a component that enables a hierarchy with the new hierarchy types on a new system installation as well as migration steps from prior versions (that don't provide the new hierarchy types) to a system with such capabilities. In this regard, prior art systems enable the use of hierarchies, but do not provide the capability to maintain or provide the new hierarchy types described above. In the prior art various tables 514 and 518 are utilized to enable the use and maintenance of hierarchies. To provide the new hierarchy types, embodiments of the invention may provide new attributes/columns in such tables 514 and 518. In this regard, the following tables may be provided with new/modified attributes/columns that may be utilized in embodiments of the present invention to provide the new functionality: Hierarchy Table, Hierarchy Object Table, Hierarchy Relationship Map Table, and Hierarchy Unbalanced Table.

The Hierarchy Table may be provided with a new column/attribute that identifies a hierarchy type as ragged, balanced, or unbalanced. An additional attribute/column of the Hierarchy Table identifies whether the table is to be made out of an MDRM table or not.

The Hierarchy Object table provides a new attribute/column that identifies whether the data of hierarchy objects resides in a table, a view (e.g., hierarchy view 516), or a code master.

The Hierarchy Relationship Map table provides a new column that determines whether a hierarchy is to be pulled from an MDRM table or not.

A new Hierarchy Unbalanced Table contains information about unbalanced types of hierarchy. As described above, unbalanced hierarchies can be built by parent-child relations in a table. Such information can be fetched from this table for a specific hierarchy. The table may include a unique hierarchy table identifier, data, a key to the parent for a hierarchy, a key to a child in the table, a relational object map identifier where the definition of parent and child for a relational object is defined, the name of the column to display in the hierarchy viewer for the hierarchy, and a sorting order for the data while building the hierarchy.

Hierarchy Viewer

The hierarchy viewer allows users with the proper authorization to view hierarchical data in a graphical display. Embodiments of the invention enable a hierarchy viewer that is user friendly with maximum graphical representation. The idea is to allow users to visualize their hierarchy data in a natural presentation mode. In this regard, messages may be provided to users for any actions performed.

Similar to the hierarchy manager, the hierarchy viewer has three components, a user interface, a business tier, and metadata specifications.

User Interface

The hierarchy viewer is built using Flex™ RIA. The user interface enables a user to view the hierarchy in a viewer by selecting a hierarchy and clicking on a view hierarchy icon. Alternatively, users may select a hierarchy from a list of available hierarchies.

Further, nodes may be searched (e.g., using a simple search) with a provision for the user to analyze different nodes whenever the search returns multiple results with a next or previous option. The search window may also show children, if any, for the node.

The user interface also provides the ability to edit data. If the user has privileges to edit data, such editing may be performed using a simple drag and drop method. Further, users may be able to cut a node from a location and paste the same node at a different location.

The user interface may also have an object-based design where the entire viewer is object-based to enable efficient and easy access.

In addition, the information for all nodes may be displayed simply by hovering (e.g., via a tooltip).

Business Tier (Webserver/J2EE)

Most of the components that are required are explained in hierarchy manager business tier section above. However, various additional components may be utilized with the Hierarchy Viewer. In one or more embodiments, the entire business tier is written in the JAVA™ programming language with stored procedures residing in the master database.

Methods may provide an XML (extensible markup language) document from a result set and return back the document to the RIA user interface.

Exception handling in case of any null returned from the data base while building a hierarchy may be provided. Further, any edit in data may invoke a call to the xcore API (application programming interface) to perform standard data persist actions on the database.

Metadata Specifications

The metadata remains the same as explained in hierarchy manager metadata specifications above.

### Logical Flow

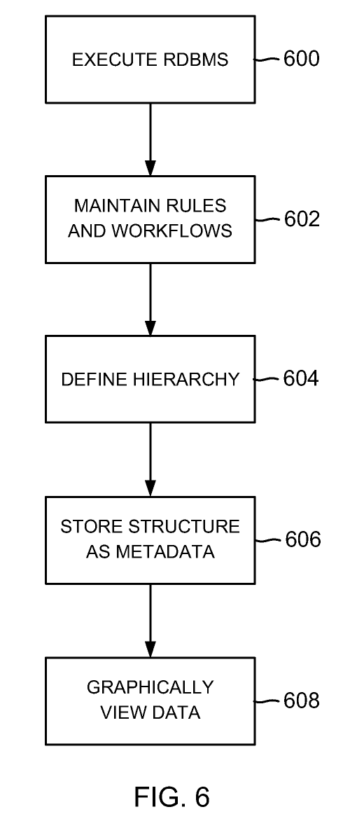

FIG. 6 is a flow chart illustrating the logical flow for visualizing a structured view of data in a computer system in accordance with one or more embodiments of the invention. At step 600, a relational database management system (RDBMS) is executed/managed in a computer system.

At step 602, as part of a process and framework, a series of business rules and process workflows (that manage data that resides in the RDBMS tables) are maintained. The data that is managed is hierarchical in nature.

At step 604, user input is accepted that defines a hierarchy that is projected onto the data. The hierarchy may take a variety of forms. In an unbalanced hierarchy, the hierarchy has parent-child relationships with no level consistency. For example, the hierarchy may have two or more branches with each branch having one or more levels where the levels of each branch are not logical equivalents. In a ragged hierarchy, the hierarchy has branches and levels where each level has a consistent meaning. However, the branches have inconsistent depths because at least one level/member of the branches is unpopulated (i.e., because there is no entry at the one level/member).

To define an unbalanced hierarchy, the relations between nodes of the hierarchy are recursively identified. Hierarchy levels are calculated for each of the nodes. Thereafter, the relations and levels are depicted as parent-child relationships in the hierarchy.

The user input is conducted via a graphical user interface (where the user is able to select/specify a type of hierarchy). Each hierarchy may define a data relationship for one or more hierarchy objects where each hierarchy object points to one or more of the RDBMS tables. Each hierarchy relationship formalizes a relationship between one or more hierarchy objects in the one or more hierarchies (e.g., a mapping from a primary key to a foreign key). As part of the framework, a mapping may be maintained. Each mapping is of each of the hierarchy objects to the relational database tables. Further, the mapping may be maintained in a hierarchy database. Metadata may be used to dynamically build an SQL statement that fetches data from the hierarchy database that is then displayed in a graphical layout.

At step 606, the hierarchy is stored as metadata in the RDBMS. Such metadata may be stored in a metadata repository (within the RDBMS) as part of the framework.

At step 608, the hierarchy is utilized to graphically visualize, manage, and manipulate the data.

### CONCLUSION

This concludes the description of the preferred embodiment of the invention. The following paragraphs describe some alternative embodiments for accomplishing the same invention. In one alternative embodiment, any type of computer or configuration of computers could be used to implement the present invention.

Hierarchy management and viewing provides many advantages, as it offers a new capability that is integrated directly into the Master Data Management Framework. Most Hierarchy Management systems require users to separate their hierarchical data from their business critical data. Hierarchical data is usually processed outside the normal business flow, and must be re-incorporated into the centralized data store, and re-integrated with their business critical data. Embodiments of the invention directly incorporate hierarchical data into the business critical data that is maintained by Master Data Management processes. In other words, the management and visualization of hierarchical data is directly integrated with Master Data Management. It allows users to define the hierarchy in a decoupled metadata format that allows for hierarchies to be used by other Master Data Management processes. It further allows for customers to view, visualize, and interact with data in a hierarchical format, while allowing this data to remain under the control of the Master Data Management Framework.

Further, embodiments of the invention provide the ability to maintain and visually represent various hierarchy types including balanced (structured), ragged, and unbalanced hierarchies.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A computer-implemented method for defining a view of data in a computer system, comprising:
(a) executing a relational database management system (RDBMS) that stores the information in the computer system;
(b) maintaining, as part of a process and framework, a series of business rules and process workflows to manage data that resides in one or more RDBMS tables, wherein the data is hierarchical in nature;
(c) accepting user input that defines a hierarchy that is projected onto the data, wherein the hierarchy comprises parent-child relationships with no level consistency;
(d) storing the hierarchy as metadata in the RDBMS; and
(e) utilizing the hierarchy to graphically visualize, manage, and manipulate the data.

2. The method of claim 1, wherein:
the hierarchy comprises two or more branches, each having one or more levels; and
the one or more levels of each branch are not logical equivalents.

3. The method of claim 1, wherein the hierarchy is defined by:
recursively identifying one or more relations between one or more nodes of the hierarchy;
calculating one or more hierarchy levels for each of the one or more nodes; and
depicting the one or more relations and one or more hierarchy levels as one or more parent-child relationships in the hierarchy.

4. The method of claim 1, wherein the user input specifies a type of hierarchy.

5. A computer-implemented method for defining a view of data in a computer system, comprising:
(a) executing a relational database management system (RDBMS) that stores the information in the computer system;
(b) maintaining, as part of a process and framework, a series of business rules and process workflows to manage data that resides in one or more RDBMS tables, wherein the data is hierarchical in nature;
(c) accepting user input that defines a hierarchy that is projected onto the data, wherein:
(1) the hierarchy has one or more branches and one or more levels;
(2) each of the one or more levels has a consistent meaning; and
(3) one of the one or more branches has inconsistent depths because at least one level of one of the one or more branches is unpopulated;
(d) storing the hierarchy as metadata in the RDBMS; and
(e) utilizing the hierarchy to graphically visualize, manage, and manipulate the data.

6. The method of claim 5, wherein the one level of the one or more branches is unpopulated because there is no entry at the one level.

7. The method of claim 5, further comprising:
calculating the one or more levels for one or more hierarchy objects of the hierarchy, wherein one of the one or more hierarchy objects is configured to have more than one link to another hierarchy object.

8. An apparatus for defining a view of data in a computer system, comprising:
(a) a relational database management system (RDBMS) executing in the computer system;
(b) a master data management system configured to maintain, as part of a process and framework, a series of business rules and process workflows to manage data that resides in one or more tables in the RDBMS, wherein the data is hierarchical in nature;
(c) a hierarchy manager, executing in the computer system configured to:
(i) accept user input that defines a hierarchy that is projected onto the data, wherein the hierarchy comprises parent-child relationships with no level consistency; and
(ii) store the hierarchical structure as metadata in the RDBMS; and
(d) a hierarchy viewer configured to utilize the hierarchical structure to graphically visualize, manage, and manipulate the data.

9. The apparatus of claim 8, wherein:
the hierarchy comprises two or more branches, each having one or more levels; and
the one or more levels of each branch are not logical equivalents.

10. The apparatus of claim 8, wherein the hierarchy is defined by:
recursively identifying one or more relations between one or more nodes of the hierarchy;
calculating one or more hierarchy levels for each of the one or more nodes; and
depicting the one or more relations and one or more hierarchy levels as one or more parent-child relationships in the hierarchy.

11. The apparatus of claim 8, wherein the user input specifies a type of hierarchy.

12. An apparatus for defining a view of data in a computer system, comprising:
(a) a relational database management system (RDBMS) executing in the computer system;
(b) a master data management system configured to maintain, as part of a process and framework, a series of business rules and process workflows to manage data that resides in one or more tables in the RDBMS, wherein the data is hierarchical in nature;
(c) a hierarchy manager, executing in the computer system configured to:
(i) accept user input that defines a hierarchy that is projected onto the data, wherein:
(1) the hierarchy has one or more branches and one or more levels;
(2) each of the one or more levels has a consistent meaning; and
(3) one of the one or more branches has inconsistent depths because at least one level of one of the one or more branches is unpopulated;
(ii) store the hierarchical structure as metadata in the RDBMS; and
(d) a hierarchy viewer configured to utilize the hierarchical structure to graphically visualize, manage, and manipulate the data.

13. The apparatus of claim 12, wherein the one level of the one or more branches is unpopulated because there is no entry at the one level.

14. The apparatus of claim 12, wherein the hierarchy manager is further configured to:
calculate the one or more levels for one or more hierarchy objects of the hierarchy, wherein one of the one or more hierarchy objects is configured to have more than one link to another hierarchy object.

15. An article of manufacture comprising a program storage device readable by a computer, tangibly embodying at least one program of instructions executable by the computer to perform method steps of defining a view of data in a computer system, the method steps comprising:
(a) executing a relational database management system (RDBMS) that stores the information in the computer system;
(b) maintaining, as part of a process and framework, a series of business rules and process workflows to manage data that resides in one or more RDBMS tables, wherein the data is hierarchical in nature;
(c) accepting user input that defines a hierarchy that is projected onto the data, wherein the hierarchy comprises parent-child relationships with no level consistency;
(d) storing the hierarchy as metadata in the RDBMS; and
(e) utilizing the hierarchy to graphically visualize, manage, and manipulate the data.

16. The article of manufacture of claim 15, wherein:
the hierarchy comprises two or more branches, each having one or more levels; and
the one or more levels of each branch are not logical equivalents.

17. The article of manufacture of claim 15, wherein the hierarchy is defined by:
recursively identifying one or more relations between one or more nodes of the hierarchy;
calculating one or more hierarchy levels for each of the one or more nodes; and
depicting the one or more relations and one or more hierarchy levels as one or more parent-child relationships in the hierarchy.

18. The article of manufacture of claim 15, wherein the user input specifies a type of hierarchy.

19. An article of manufacture comprising a program storage device readable by a computer, tangibly embodying at least one program of instructions executable by the computer to perform method steps of defining a view of data in a computer system, the method steps comprising:
(a) executing a relational database management system (RDBMS) that stores the information in the computer system;
(b) maintaining, as part of a process and framework, a series of business rules and process workflows to manage data that resides in one or more RDBMS tables, wherein the data is hierarchical in nature;
(c) accepting user input that defines a hierarchy that is projected onto the data, wherein:
(1) the hierarchy has one or more branches and one or more levels;
(2) each of the one or more levels has a consistent meaning; and
(3) one of the one or more branches has inconsistent depths because at least one level of one of the one or more branches is unpopulated;
(d) storing the hierarchy as metadata in the RDBMS; and
(e) utilizing the hierarchy to graphically visualize, manage, and manipulate the data.

20. The article of manufacture of claim 19, wherein the one level of the one or more branches is unpopulated because there is no entry at the one level.

21. The article of manufacture of claim 19, the method further comprising:
calculating the one or more levels for one or more hierarchy objects of the hierarchy, wherein one of the one or more hierarchy objects is configured to have more than one link to another hierarchy object.
